(19) United States
(12) Patent Application Publication
(10) Pub. No.: US 2026/0287210 A1
(43) Pub. Date: Sep. 24, 2026

(54) Exhaust Flue for Water Heater

(71) Applicant: Rheem Manufacturing Company, Atlanta, GA (US)

(72) Inventors: Nigel Wei Kam, Santa Paula, CA (US); Hiram Osuna Carrasco, Oxnard, CA (US); Stephen Thomas Thurlkill, Newbury Park, CA (US); Jorge Miguel Gamboa Revilla, Oxnard, CA (US); Peachie Andrea Grace Maher, Agoura Hills, CA (US)

(21) Appl. No.: 19/569,338

(22) Filed: Mar. 17, 2026

Related U.S. Application Data
(60) Provisional application No. 63/773,857, filed on Mar. 18, 2025.

(51) Int. Cl. F24H 15/33; F24H 9/00; F24H 15/20; F24H 15/35

(52) U.S. Cl. CPC F24H 15/33; F24H 9/0026; F24H 15/20; F24H 15/35

(57) ABSTRACT

Disclosed is an exhaust flue for a water heater that allows a condensing water heater that is configured for a first category of exhaust venting (for example, category four venting) to be installed with an existing exhaust vent within a building that is configured for a second category of exhaust venting (for example, category one venting). The exhaust flue allows for a non-condensing water heater that was already installed within the building to be replaced with the more efficient condensing water heater while keeping the existing exhaust vent system within the building. Without the use of the exhaust flue as described herein, the entire existing exhaust venting system may need to be replaced with a new exhaust venting system configured for the same category of venting as the new condensing water heater.

### CROSS-REFERENCE TO RELATED APPLICATIONS

This application claims priority to and benefit of U.S. provisional patent application no. 63/773,857 filed Mar. 18, 2025, which is herein incorporated by reference.

### TECHNICAL FIELD

The present disclosure is generally in the field of water heaters.

### BACKGROUND

Condensing water heaters typically use condensation to trap heat which can then be recycled back into the water heater to supplement the heating performed by the water heater, rather than allowing all of the heat to dissipate into the atmosphere. A condensing water heater may also use an additional heat exchanger to recover the heat generated by the exhaust gases (also referred to as “flue gases” herein) resulting from the fuel combustion process that occurs within the water heater. Some condensing water heaters may also achieve increased efficiency in other ways as well (without requiring the additional heat exchanger). These types of condensing water heaters are often configured for use with “category four” venting systems. Category four venting systems are used for high-efficiency appliances, like condensing furnaces or boilers, which operate with a positive vent pressure.

In contrast with condensing water heaters, non-condensing water heaters typically do not include the secondary heat exchanger to recover the heat from the exhaust gases produced as a byproduct of the combustion process. As a result, the exhaust gases are released without being recycled back into the water heater, causing the non-condensing water heaters to be less efficient than condensing water heaters. These types of non-condensing water heaters are often configured for use with “category one” venting systems. Category one venting systems are instead associated with a neutral (e.g., atmospheric) or negative vent pressure.

As non-condensing water heaters were previously more prevalent, buildings often include exhaust venting configured for use with such non-condensing units. That is, most buildings may have exhaust venting installed that is configured for category one venting associated with neutral or negative pressures. New regulations (such as the DOE Energy Conservation Standard for Commercial Water Heating Equipment) are driving a shift from the existing non-condensing water heaters to the more efficient condensing water heaters. However, these condensing water heaters may be incompatible with the existing exhaust vents installed in the buildings given the different categories of venting required for condensing and non-condensing water heaters. This results in challenges associated with converting a building's water heating system from a system including a non-condensing water heater to a system including a condensing water heater.

### BRIEF DESCRIPTION OF THE DRAWINGS

FIGS. 1A-1C illustrate a water heating system including an exhaust flue kit, in accordance with one or more embodiments of the disclosure.

FIG. 2 illustrates a water heater system including common venting, in accordance with one or more embodiments of the disclosure.

FIG. 3 illustrates a method associated with an exhaust flue for a water heater, in accordance with one or more embodiments of the disclosure.

FIG. 4 illustrates an exemplary computing device, in accordance with one or more embodiments of the disclosure.

### DETAILED DESCRIPTION

The present disclosure is directed to an exhaust flue for a water heater. Specifically, the exhaust flue is configured to provide an interface between a condensing water heater that is configured for a first category of exhaust venting (for example, category four venting) and an existing exhaust vent system within a building that is configured for a second category of exhaust venting (for example, category one venting). This allows for a non-condensing water heater that was already installed within the building to be replaced with a more efficient condensing water heater (in accordance with new regulations) without needing to also replace the existing exhaust vent system within the building (which may be a complicated and costly process). Without the use of the exhaust flue as described herein, the entire existing exhaust venting system may need to be replaced with a new exhaust venting system configured for the same category of venting as the new condensing water heater.

In one or more embodiments, the exhaust flue as described herein may be provided as a “kit” that may be installed to connect the condensing water heater to the existing exhaust vent of the building. For example, the kit may include various types of exhaust flue tubing that may be connected between the condensing water heater and the existing exhaust vent. The types of tubing and the size and shape of the tubing included in the kit may vary depending on a number of different factors (as non-limiting examples, the configuration of the building, the location of an existing exhaust vent relative to the water heater, obstacles that exist in the building, such as walls, and/or any other factors).

The kit may also include other components that facilitate the change in pressure from the positive pressure associated with the category four venting (the pressure output from the condensing water heater) to the neutral or negative pressure associated with the category one venting (the pressure requirements of the existing exhaust venting configured for the prior non-condensing water heater). A technician may combine the elements of the kit during the installation process to form the exhaust flue. The exhaust flue may then be installed between the condensing water heater and the existing exhaust vent. However, in some instances, the exhaust flue may be provided pre-configured such that the exhaust flue is already ready for the technician to install between the condensing water heater and the existing exhaust vent. In some instances, the technician may also be able to choose between different components that may be better suited depending on the space in which the exhaust flue is installed. For example, certain combinations of tubes and connectors between the tubes may be used depending on the location of the water heater within the building, the presence of obstacles near the water heater, etc.

In one or more embodiments, the exhaust flue may include multiple portions including tubing of different sizes to cause the necessary pressure reduction before the flue gases reach the existing exhaust vent. For example, the exhaust flue may include a first portion with tubing configured for category four venting. Connected to the first portion may be a second portion with tubing that is configured for category one venting. The tubing in the second portion may be larger in diameter than the tubing in the first portion. Accordingly, as the flue gases flow from the first portion to the larger second portion, the flue gases expand within the second portion and the pressure decreases. Thus, the pressure associated with the flue gases naturally transitions from the positive pressure associated with the category four operation of the condensing water heater to the neutral or negative pressure associated with the category one exhaust vent as the flue gases flow from the first portion to the second portion of the exhaust flue.

In one or more embodiments, the exhaust flue may also include other components to facilitate the pressure reduction from the positive pressure associated with the condensing water heater and the neutral or negative pressure suitable for the existing exhaust vent. These components may supplement the pressure reduction caused by the two portions. In some instances, the components themselves may facilitate the pressure reduction and the two different sized portions may not necessarily be required.

As a first example of such a component, the exhaust flue may include one or more dampers. In one or more embodiments, the exhaust flue may specifically include an airflow damper and an intake air damper, however, any other number of dampers may also be provided. A damper may generally refer to a movable plate or valve (or other type of mechanical or electromechanical element) that may be adjusted to control the amount of airflow that passes through the damper. Any number of different types of dampers may be used, such as automatic dampers, manual dampers, parallel dampers, opposed dampers, balance dampers, bypass dampers, and fire dampers, as non-limiting examples. The dampers may be mechanically or electrically actuated (or a combination thereof). For example, if the dampers are electrically actuated, a controller may send signals to the dampers that cause the dampers to actuate by a given amount (depending on the signal provided by the controller) to regulate the amount of airflow through the dampers.

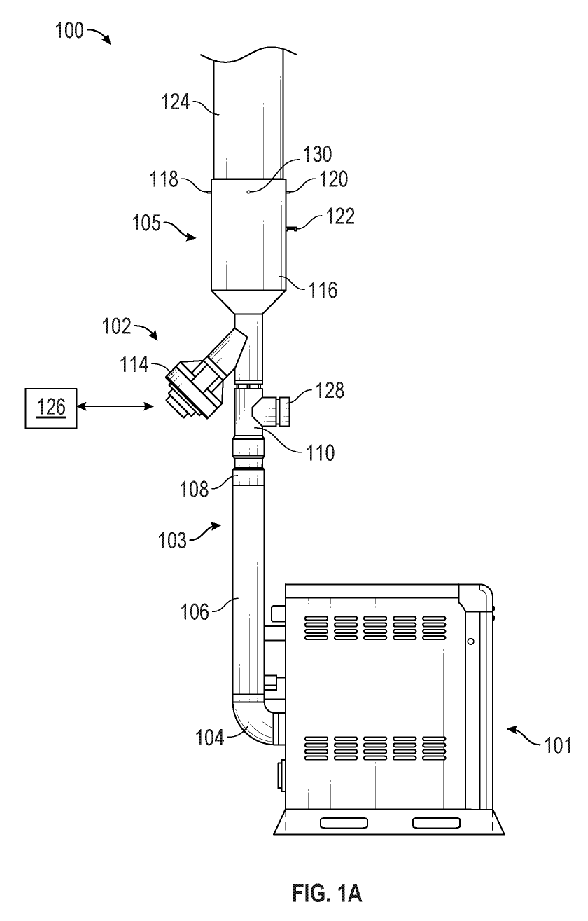

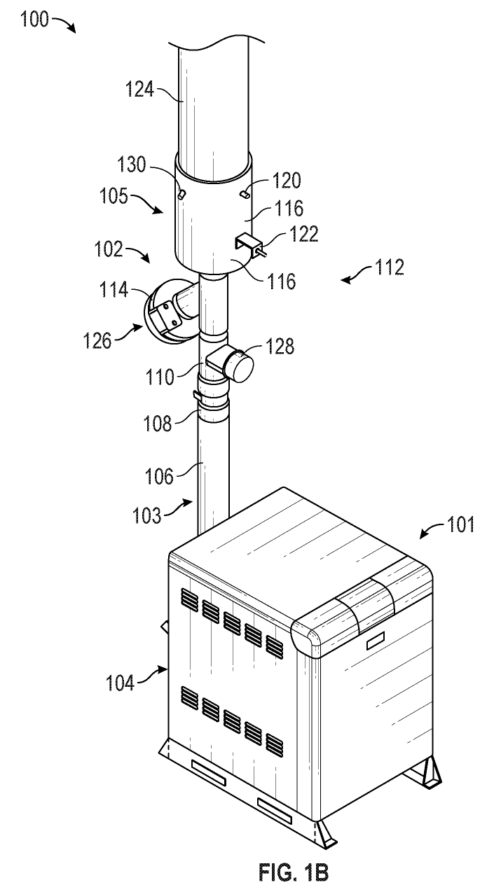

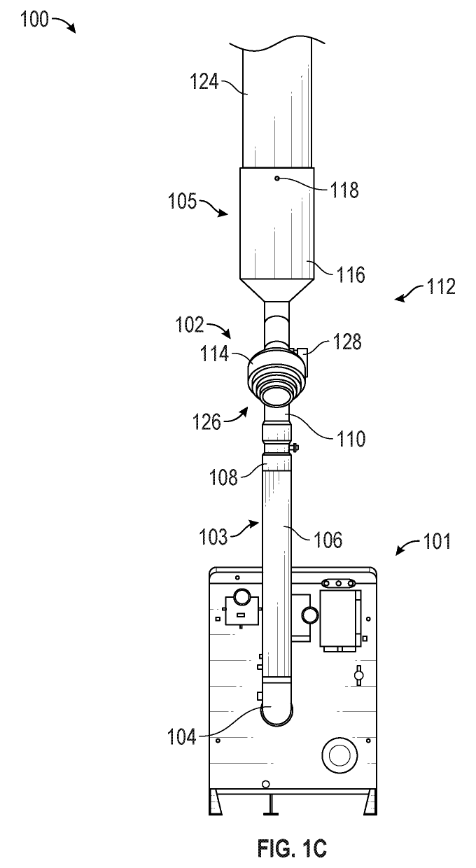

As a second example of a component, the exhaust flue may include one or more fans. The one or more fans may be variable speed fans or fixed speed fans (or a combination thereof) configured to control the flow rate of the flue gases through the exhaust flue. The one or more fans may be provided within the tubing of the exhaust flue (e.g., “in-line” with the exhaust flue) or may be provided at an offset from the exhaust flue (as shown in FIGS. 1A-1C). The speed of the one or more fans may also be selectively controlled by the controller such that the fan speed may be increased or decreased (or the fan may be turned off) based on control signals from the controller.

The dampers and fans are merely examples of additional types of components that may be provided in the exhaust flue to reduce the pressure from the positive pressure to the neutral or negative pressure and any other components may also be used as well. For example, while reference is made to the exhaust flue including two different types of dampers and one or more fans, this configuration is merely exemplary. As another example, the exhaust flue may include one of the types of dampers or may include only the fan or a combination of only one of the types of dampers and a fan. The exhaust flue may also include additional components other than one or more fans and one or more dampers that may facilitate a pressure reduction within the exhaust flue. Any of the components may be any number of different shapes and/or sizes and may be provided in any arrangement. A specific example of a combination of different components that may be used in an exhaust flue is described in further detail with respect to at least FIGS. 1A-1C.

In one or more embodiments, the exhaust flue may be further configured to minimize the amount of moisture within the exhaust flue. Moisture in flue gases from a water heater is undesirable because the moisture can lead to condensation within the flue pipe, causing corrosion and potential damage to the venting system, for example. Accordingly, one or more moisture sensors may be provided within the exhaust flue to measure the moisture content of the flue gases flowing through the exhaust flue (and/or the moisture within the exhaust flue generally). In some instances, multiple moisture sensors may be provided for redundancy (and so that the system can detect moisture levels even if one of the moisture sensors fails). Another moisture sensor (or multiple additional moisture sensors) may also be provided to measure the moisture content of the air in the external environment. This additional moisture data is also important if air from the external environment is being introduced into the exhaust flue (for example, via the intake air damper, etc.).

Any of the data captured by any of these moisture sensors may be transmitted to a controller for processing. If the controller determines, based on the data from the moisture sensor(s), that there is an excessive amount of moisture within the exhaust flue, then the controller may send control signals to components of the exhaust flue to cause the components of the exhaust flue to perform actions to reduce the moisture levels. For example, the controller may send a control signal to a fan of the exhaust flue to increase the speed of the fan to increase the flow of air through the exhaust flue. If the moisture levels persist, then the controller may send a signal for the water heater to be disabled for at least a period of time. An “excessive” amount of moisture may be determined, for example, by comparing the moisture levels determined by the one or more moisture sensors to a threshold value. If the moisture levels fail to satisfy the threshold value, then it may be determined that the moisture levels are “excessive”. Failing to satisfy the threshold value may refer to the moisture levels being greater than or greater than or equal to the threshold value, depending on how the water heating system is configured. The determination that an excessive amount of moisture is present may also be made in any other manner as well.

Although reference is made to specific categories of venting (for example, category four and category one) herein, this is not intended to be limiting and the exhaust flue may also be used as an interface between a water heater configured for another category of venting and an existing exhaust vent also configured for another category of venting. Accordingly, any reference herein to category four venting or category one venting is not intended to be limiting and may be replaced by other categories of venting. Additionally, although reference is made to certain non-condensing water heaters and condensing water heaters, it should be understood that a similar type of exhaust flue may be used with a variety of types of water heaters (for example, tankless water heaters, tank water heaters, boilers, pool heaters, etc.) or other types of heating and/or cooling appliances in general (any type of heating and/or cooling appliance that produces flue gases as a byproduct of a combustion process, for example). As further non-limiting examples, the same, or a similar, exhaust flue may be used for hydronic systems, boilers, storage tanks, etc.

Additionally, although the figures(described below) show the exhaust flue as described herein as being located outside of the water heater (or other type of heating and/or cooling appliance), this configuration is not intended to be limiting. For example, some or all of the components of the exhaust flue “kit” may also be installed within the water heater (or other type of heating and/or cooling appliance) itself.

Turning to the figures, FIGS. 1A-1C illustrate a water heating system 100. Specifically, FIG. 1A shows a side view of the water heating system 100, FIG. 1B shows a perspective view of the water heating system 100, and FIG. 1C shows a rear view of the water heating system 100.

In one or more embodiments, the water heating system 100 includes a condensing water heater 101, an existing exhaust vent 124, and an exhaust flue 102 that serves as an interface between the condensing water heater 101 and the existing exhaust vent 124. That is, the existing exhaust vent 124 was previously installed in the building (which may be a residential home, a commercial establishment, etc.) for use with a non-condensing water heater that is replaced with the condensing water heater 101 shown in FIGS. 1A-1C. As an example, the exhaust vent 124 may include a tube or a series of tubes that direct the flue gases produced by the water heater 101 to the external environment outside of the building in which the water heating system 100 is installed. However, the exhaust vent 124 may also include any other type of structure or structures known in the art used to direct the flue gases outside of the building. The exhaust flue 102 allows for the condensing water heater 101 to replace the non-condensing water heater without also needing to replace the remainder of the existing exhaust vent system as well (that is, only the non-condensing water heater itself is removed).

As indicated above, the previously installed non-condensing water heater and the existing exhaust vent 124 may be configured for a first category of venting. For example, the existing exhaust vent 124 may be configured for “category one” venting in which the pressure in the exhaust vent is a neutral or negative pressure. However, the more efficient condensing water heater 101 that replaces the non-condensing water heater may be configured for a second category of venting. For example, the condensing water heater 101 may be configured for “category four” venting in which the pressure in the exhaust vent is a positive pressure. The exhaust flue 102 in this water heater system 100 is specifically configured to provide an interface between the condensing water heater 101 and the exhaust vent 124 that allows the category four condensing unit to be used with the existing category one exhaust vent 124. As indicated above, this allows for the non-condensing water heater to be replaced with the more efficient condensing water heater 101 without having to replace the existing exhaust vent 124 and any other elements of the water heating system 100 that are used to direct the flue gases outside of the building, which, as indicated above, may be a complicated and costly process.

As indicated above, exhaust flue 102 may be provided as a “kit” that may be installed to connect the condensing water heater 101 to the existing exhaust vent 124 of the building. Specifically, the exhaust flue 102 may be connected to the condensing water heater 101 to receive flue gases from a heat exchanger of the condensing water heater 101 as a byproduct of a combustion process that takes place within the condensing water heater 101. For example, the kit may include various types of exhaust flue tubing that may be connected between the condensing water heater 101 and the existing exhaust vent 124. The types of tubing and the size and shape of the tubing included in the kit may vary depending on a number of different factors (as non-limiting examples, the configuration of the building, the location of an existing exhaust vent relative to the condensing water heater 101, obstacles that exist in the building (e.g., walls, etc.), and/or any other factors. A technician may combine the elements of the kit during the installation process to form the exhaust flue 102. The exhaust flue 102 may then be installed between the condensing water heater 101 and the existing exhaust vent 124. However, in some instances, the exhaust flue 102 may be provided pre-configured such that the exhaust flue 102 is already ready for the technician to install between the condensing water heater 101 and the existing exhaust vent 124.

To reduce the pressure from the positive pressure produced by the condensing water heater 101 to the neutral or negative pressure for which the existing exhaust vent 124 is configured, the exhaust flue 102 may include multiple portions of different diameters (such that the internal volume of one portion is larger than the internal volume of another portion). That is, the exhaust flue 102 may include a first portion 103 including tubing that is configured for category four venting and a second portion 105 that is configured for category one venting. For example, if 4” venting is used in the first portion 103, then the second portion 105 may double in size to 8” (however, these values are merely exemplary). The venting size may vary based on the desired pressure drop.

In the exemplary configuration shown in FIG. 1A, the first portion includes at least a straight tube 106 and an elbow tube 104 (a bent tube section). The tubing of the first portion 103 may be made from any material or combination of materials. As one non-limiting example, the tubing of the first portion 103 may be made from a stainless steel material. The tubing of the first portion 103 may be any shape and/or size. Additionally, while the first portion is shown as including the straight tube 106 and an elbow tube 104, this specific configuration is not intended to be limiting and the first tubing may be routed from the condensing water heater 101 in any other suitable manner using any other combination of different types of tubes (or a single tube).

Connected to the first portion 103 is the second portion 105 including tubing that is configured for category one venting. The tubing in at least a portion of the second portion 105 may be larger in diameter than the tubing in the first portion 103. By providing this difference in size between the first portion 103 and the second portion 105, the pressure associated with the flue gases decreases as the flue gases spread out into the larger tubing of the second portion 105. This allows the pressure associated with the flue gases to transition from the positive pressure associated with the category four operation of the condensing water heater 101 to the neutral or negative pressure associated with the category one exhaust vent 124. In one or more embodiments, an extractor fan may also be added within the exhaust vent 124 or the second portion 105 to create negative pressure in the system.

While reference is made herein to the exhaust flue 102 including a first portion 103 and a second portion 105, this is not intended to be limiting and the exhaust flue 102 may also include any other number of portions of varying diameters. For example, the exhaust flue 102 may also include a third portion that is larger in diameter than the second portion 105 and provided between the second portion 105 and the exhaust vent 124. The third portion may also be of a diameter that is less than the diameter of the second portion 105 but greater in diameter than the first portion 103 and may be provided between the first portion 103 and the second portion 105. The exhaust flue 102 may also include any other number of portions that are each successively larger than the previous (for example, four portions, five portions, etc.). In this manner, rather than one sudden change in volume, there may be several smaller changes in volume such that the pressure decreases at a more gradual rate. The exhaust flue 102 (as well as any other exhaust flue described herein) may also be of an integral construction or may be formed by multiple parts connected together (for example, using fasteners or other suitable connection mechanisms).

In one or more embodiments, in addition to using tubing in the second portion 105 that is larger in diameter than the tubing in the first portion 103 to reduce the pressure of the flue gases in the second portion 105, the pressure reduction that allows the condensing water heater 101 to interface with the existing exhaust vent 124 may be supplemented using one or a combination of multiple different components of the exhaust flue 102. In some instances, the size difference between the first portion 103 and the second portion 105 may be sufficient in itself to reduce the pressure. However, in some instances, the additional components may partially reduce the positive pressure and the larger second portion 105 may further reduce the pressure to the desired neutral or negative pressure. In even further instances, the additional components themselves may sufficiently reduce the pressure to the desired neutral or negative pressure without necessarily requiring the size difference provided in the second portion 105. Providing the additional components also allows for the exhaust flue 102 to adapt to dynamic conditions associated with the condensing water heater 101 and the environment in which the condensing water heater 101 is installed. For example, the size difference between the first portion 103 and the second portion 105 may provide a sufficient pressure reduction in some conditions, but in other conditions, the additional components may be used to further reduce the pressure of the flue gases. Examples of such components are illustrated in FIGS. 1A-1C.

As a first example, the exhaust flue 102 may include one or more dampers. For example, the exhaust flue 102 may include an airflow damper 108 and/or an intake air damper 128. The dampers may be mechanically or electrically actuated (or a combination thereof). For example, if the dampers are electrically actuated, a controller 126 may send signals to the dampers that cause the dampers to actuate by a given amount (depending on the signal provided by the controller 126) to regulate the amount of airflow through the dampers.

The airflow damper 108 may be provided within the exhaust flue 102 (e.g., in line with the exhaust flue) such that the airflow damper 108 may be adjusted within the exhaust flue 102 to control the flow of flue gases through the exhaust flue 102. For example, the airflow damper 108 may be actuated to a first position to allow a first amount of flue gases to flow through the airflow damper 108 at any given time and may be actuated to a second position to allow a second amount of flue gases to flow through the airflow damper 108 at any given time (or may be actuated to any other number of positions). As indicated above, the pressure of the flue gases from the condensing water heater 101 is a positive pressure (given that the condensing water heater 101 operates as a category four system, for example), so the airflow damper 108 reduces the amount of pressure within the exhaust flue 102.

The intake air damper 128 may protrude from a sidewall of the exhaust flue 102 such that the intake air damper 128 may regulate the flow of air from the external environment into the exhaust flue 102 to mix with the flue gases. Similar to the airflow damper 108, the intake air damper 128 may be adjusted within the exhaust flue 102 to control the flow of air from the external environment into the exhaust flue 102. For example, the intake air damper 128 may be actuated to a first position to allow a first amount of external air to flow into the exhaust flue 102 at any given time and may be actuated to a second position to allow a second amount of external air to flow into the exhaust flue 102 at any given time (or may be actuated to any other number of positions). Although the intake air damper 128 is shown as being positioned perpendicularly or substantially perpendicularly to the exhaust flue 102, this is merely exemplary and the intake air damper 128 may also be provided at any other angle relative to the exhaust flue 102.

As a second example of a component, the exhaust flue 102 may include a ducting fan 114. The ducting fan 114 may be a variable speed fan or a fixed speed fan that is configured to control the flow rate of the flue gases through the exhaust flue 102. As shown in FIG. 1A, the ducting fan 114 may be provided offset from the main tube of the exhaust flue 102, however, this configuration is not intended to be limiting. The ducting fan 114 may also be provided within the exhaust flue 102 (e.g., “inline” with the exhaust flue 102) or in any other suitable configuration.

In one or more embodiments, another consideration for the operation of the exhaust flue 102 may be the amount of moisture associated with the flue gases flowing through the exhaust flue 102. If there is an excessive amount of moisture within the exhaust flue 102, then the control 126 may send control signals to components of the exhaust flue 102 to reduce the moisture levels. For example, the controller 126 may send a control signal to the ducting fan 114 (and/or another fan) to increase a speed of the fan to increase the flow of air through the exhaust flue 102. If the moisture levels persist, then the controller 126 may send a signal for the condensing water heater 101 to be disabled for at least a period of time. An “excessive” amount of moisture may be determined by comparing the moisture levels determined by the one or more moisture sensors to a threshold value. If the moisture levels fail to satisfy the threshold value then it may be determined that the moisture levels are “excessive”. As indicated above, failing to satisfy the threshold value may refer to the moisture levels being greater than or greater than or equal to the threshold value, depending on how the water heating system 100 is configured.

Accordingly, one or more moisture sensors (for example, moisture sensors 118 and 120) may be provided within the exhaust flue 102 to measure the moisture content of the flue gases flowing through the exhaust flue 102 (and/or the moisture within the exhaust flue 102 generally). As shown in FIG. 1A, multiple of such moisture sensors may be provided for redundancy (and so that the system can detect moisture levels even if one of the moisture sensors fails). Another moisture sensor 122 (or multiple additional moisture sensors) may also be provided to measure the moisture content of the air in the external environment. This moisture data also may be important if air from the external environment is being introduced into the exhaust flue 102 (for example, via the intake air damper 128, etc.).

It should be noted that the specific configuration of the exhaust flue 102 shown in FIGS. 1A-1C is merely exemplary and other configurations may also be possible. That is, other configurations may also be possible in which the size, shape, orientation, and location of the components on or within the exhaust flue 102 may vary. Additionally, some configurations may have fewer or additional components than those shown in FIG. 1A. As one non-limiting example, one configuration may use only one of the dampers shown in FIG. 1A or may include the dampers but may not include the ducting fan 114. As another non-limiting example, the exhaust flue 102 may include both dampers and the ducting fan 114, but the ducting fan 114 may be positioned between the two dampers rather than above the two dampers. These are merely some examples of configuration changes and any other type of configuration change may also be possible.

Any of the components of the condensing water heater 101 may be selectively controlled by the controller 126. For example, as described in some detail above, the controller 126 may be configured to send signals to the dampers to actuate the dampers to regulate the flow of flue gases through the exhaust flue 102 (using the airflow damper 108) and the flow of external air into the exhaust flue (using the intake air damper 128). Likewise, the controller 126 may be configured to send signals to the ducting fan 114 (or any other fan) to control the speed of the ducting fan 114 to regulate the flow of flue gases through the exhaust flue 102. The controller 126 may also be configured to send control signals to any other components that may be provided on or within the exhaust flue 102 to reduce the pressure of the flue gases from a positive pressure to a neutral or negative pressure.

The controller 126 may also more specifically be configured to send such control signals based on data received from any sensors of the water heating system 100 or sensors external to the water heating system 100. For example, the controller 126 may receive moisture data from the one or more moisture sensors described above and may send control signals based on the moisture data. However, the moisture sensors are merely one example of a type of sensor that may be included and other sensors may also be provided. For example, a pressure sensor may be provided or multiple pressure sensors may be provided at various locations within the exhaust flue 102. The pressure data from the pressure sensors may provide an indication of whether the exhaust flue 102 is sufficiently dropping the pressure of the flue gases from the positive pressure to the neutral or negative pressure for exhausting through the exhaust vent 124. As one example, one or more pressure sensors, such as pressure sensor 130, may be provided within the second portion 105 of the exhaust flue 102 to determine if the pressure is neutral or negative within the second portion 105. If the pressure is not neutral or negative, the controller 126 may send a signal to one or more components of the exhaust flue to further reduce the pressure. Other types of sensors may also provide beneficial data, such as flow rate sensors, temperature sensors, etc.

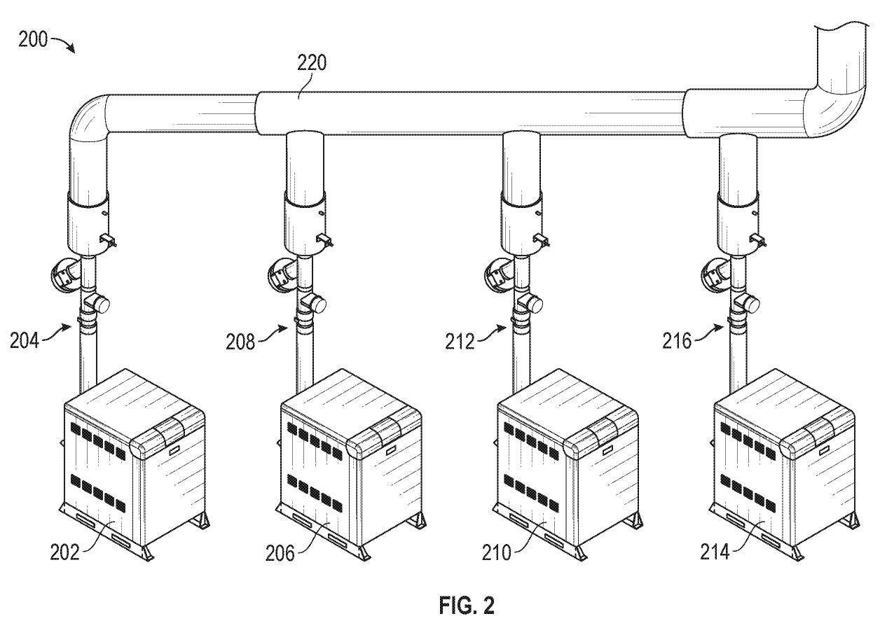

FIG. 2 illustrates a water heater system 200 including common venting. Specifically, FIG. 2 shows that the exhaust flue as described herein (for example, the exhaust flue 102 shown in FIGS. 1C-1C) may be installed on any number of condensing water heaters that are included in a building. That is, multiple condensing water heaters configured for category four venting may be attached to category one exhaust venting (again, these categories are merely exemplary). For example, FIG. 2 shows a first condensing water heater 202 with a first exhaust flue 204, a second condensing water heater 206 with a second exhaust flue 208, a third condensing water heater 210 with a third exhaust flue 212, a fourth condensing water heater 214 with a fourth exhaust flue 216, and/or any other number of condensing water heaters. Each of the exhaust flues may be connected to a common exhaust vent 220. Additionally, although the figure only shows condensing water heaters including the exhaust flue as described herein, it should be noted that one or more non-condensing water heaters may also be connected to the common exhaust vent 220 as well. In this manner, if a building includes multiple non-condensing water heaters, one or some of the non-condensing water heaters may be replaced with condensing water heaters at a time, rather than all of the non-condensing water heaters needing to be replaced with condensing water heaters at a single time for the system to continue to operate.

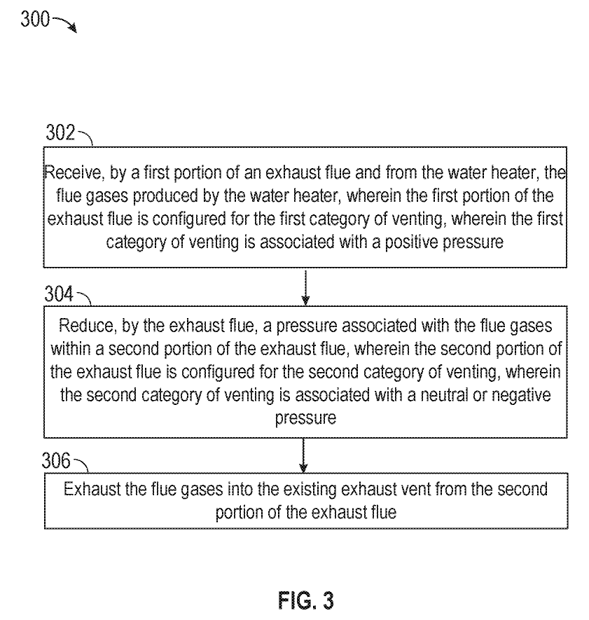

Referring now to FIG. 3, an example method 300 associated with an exhaust flue for a water heater is shown. Some or all of the blocks of the process flows or methods in this disclosure may be performed in a distributed manner across any number of devices or systems (for example, the controller 126, computing device 400, etc.). The operations of the method 300 may be optional and may be performed in a different order.

At block 302 of the method 300, computer-executable instructions stored on a memory of a system or device may be executed to receive, by a first portion (for example, first portion 103) of an exhaust flue (for example, exhaust flue 102, etc.) and from the water heater (for example, water heater 101, etc.), the flue gases produced by the water heater, wherein the first portion of the exhaust flue is configured for the first category of venting, wherein the first category of venting is associated with a positive pressure. For example, the first category of venting may be category four venting and the water heater may be a condensing water heater, such as condensing water heater 201 described above with respect to FIGS. 1A-1C.

At block 304 of the method 300, computer-executable instructions stored on a memory of a system or device may be executed to reduce, by the exhaust flue, a pressure associated with the flue gases within a second portion (for example, second portion 105) of the exhaust flue, wherein the second portion of the exhaust flue is configured for the second category of venting, wherein the second category of venting is associated with a neutral or negative pressure. For example, the second category of venting may be category one venting associated with an existing exhaust vent that may have previously been installed in a building for use with a less efficient non-condensing water heater.

At block 306 of the method 300, computer-executable instructions stored on a memory of a system or device may be executed to exhaust the flue gases into the existing exhaust vent (for example, existing exhaust vent 124) from the second portion of the exhaust flue.

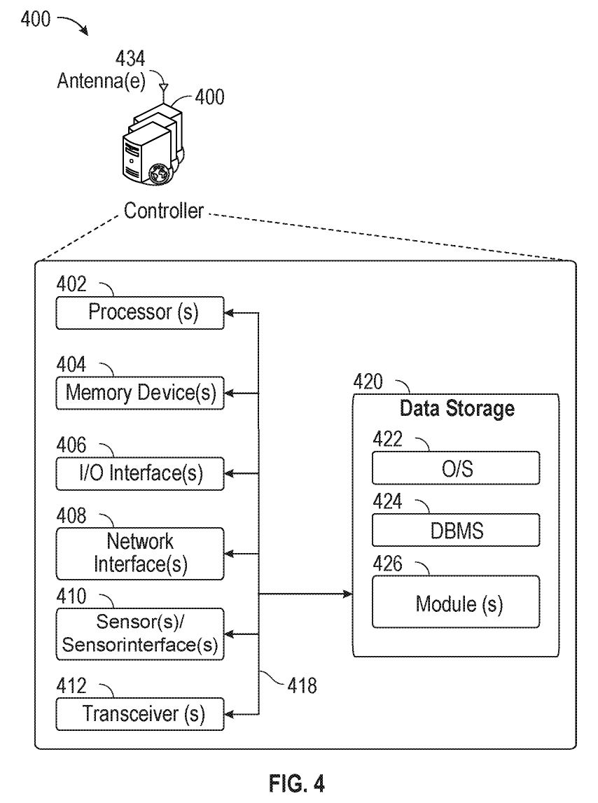

Referring now to FIG. 4, a schematic block diagram of one or more illustrative computing device(s) 400 is shown. The computing device(s) 400 may include any suitable computing device including, but not limited to, a controller (e.g., any of the controllers described herein, such as controller 126, etc.), etc.

The computing device(s) 400 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device(s) 400 may include one or more processors (processor(s)) 402, one or more memory devices 404 (generically referred to herein as memory 404), one or more input/output (I/O) interfaces 406, one or more network interfaces 408, one or more sensors or sensor interfaces 410, one or more transceivers 412, one or more optional speakers 414, one or more optional microphones 416, and data storage 420. The computing device(s) 400 may further include one or more buses 418 that functionally couple various components of the computing device(s) 400. The computing device(s) 400 may further include one or more antenna(e) 434 that may include, without limitation, a cellular antenna for transmitting or receiving signals to/from a cellular network infrastructure, an antenna for transmitting or receiving WiFi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 418 may include at least one of a system bus, a memory bus, an address bus, or a message bus, and may permit the exchange of information (e.g., data (including computer-executable code), signaling, etc.) between various components of the computing device(s) 400. The bus(es) 418 may include, without limitation, a memory bus or a memory controller, a peripheral bus, an accelerated graphics port, and so forth. The bus(es) 418 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 404 of the computing device(s) 400 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 404 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 404 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 420 may include removable storage and/or non-removable storage, including, but not limited to, magnetic storage, optical disk storage, and/or tape storage. The data storage 420 may provide non-volatile storage of computer-executable instructions and other data. The memory 404 and the data storage 420, removable and/or non-removable, are examples of computer-readable storage media (CRSM) as that term is used herein.

The data storage 420 may store computer-executable code, instructions, or the like that may be loadable into the memory 404 and executable by the processor(s) 402 to cause the processor(s) 402 to perform or initiate various operations. The data storage 420 may additionally store data that may be copied to the memory 404 for use by the processor(s) 402 during the execution of the computer-executable instructions. Moreover, output data generated as a result of execution of the computer-executable instructions by the processor(s) 402 may be stored initially in the memory 404, and may ultimately be copied to the data storage 420 for non-volatile storage.

More specifically, the data storage 420 may store one or more operating systems (O/S) 422; one or more database management systems (DBMSs) 424; and one or more program module(s), applications, engines, computer-executable code, scripts, or the like such as, for example, one or more data management module(s) 426, one or more data analysis module(s) 428, and/or one or more OBD module(s) 430. Some or all of these module(s) may be sub-module(s). Any of the components depicted as being stored in the data storage 420 may include any combination of software, firmware, and/or hardware. The software and/or firmware may include computer-executable code, instructions, or the like that may be loaded into the memory 404 for execution by one or more of the processor(s) 402. Any of the components depicted as being stored in the data storage 420 may support functionality described in reference to corresponding components named earlier in this disclosure.

The data storage 420 may further store various types of data utilized by the components of the computing device(s) 400. Any data stored in the data storage 420 may be loaded into the memory 404 for use by the processor(s) 402 in executing computer-executable code. In addition, any data depicted as being stored in the data storage 420 may potentially be stored in one or more datastore(s) and may be accessed via the DBMS 424 and loaded in the memory 404 for use by the processor(s) 402 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like.

The processor(s) 402 may be configured to access the memory 404 and execute the computer-executable instructions loaded therein. For example, the processor(s) 402 may be configured to execute the computer-executable instructions of the various program module(s), applications, engines, or the like of the computing device(s) 400 to cause or facilitate various operations to be performed in accordance with one or more embodiments of the disclosure. The processor(s) 402 may include any suitable processing unit capable of accepting data as input, processing the input data in accordance with stored computer-executable instructions, and generating output data. The processor(s) 402 may include any type of suitable processing unit including, but not limited to, a central processing unit, a microprocessor, a reduced instruction set computer (RISC) microprocessor, a complex instruction set computer (CISC) microprocessor, a microcontroller, an application-specific integrated circuit (ASIC), a field-programmable gate array (FPGA), a system-on-a-chip (SoC), a digital signal processor (DSP), and so forth. Further, the processor(s) 402 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 402 may be capable of supporting any of a variety of instruction sets.

Referring now to functionality supported by the various program module(s) depicted in FIG. 6, the module(s) 426 may include computer-executable instructions, code, or the like that responsive to execution by one or more of the processor(s) 402 may perform any of the functions associated with the controlling any of the components of the exhaust flue as described herein.

Referring now to other illustrative components depicted as being stored in the data storage 420, the O/S 422 may be loaded from the data storage 420 into the memory 404 and may provide an interface between other application software executing on the computing device(s) 400 and the hardware resources of the computing device(s) 400. More specifically, the O/S 422 may include a set of computer-executable instructions for managing hardware resources of the computing device(s) 400 and for providing common services to other application programs (e.g., managing memory allocation among various application programs). The O/S 422 may include any operating system now known or which may be developed in the future, including, but not limited to, any server operating system, any mainframe operating system, or any other proprietary or non-proprietary operating system.

The DBMS 424 may be loaded into the memory 404 and may support functionality for accessing, retrieving, storing, and/or manipulating data stored in the memory 404 and/or data stored in the data storage 420. The DBMS 424 may use any of a variety of database models (e.g., relational model, object model, etc.) and may support any of a variety of query languages. The DBMS 424 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computing device(s) 400 is a mobile device, the DBMS 424 may be any suitable lightweight DBMS optimized for performance on a mobile device.

Referring now to other illustrative components of the computing device(s) 400, the input/output (I/O) interface(s) 406 may facilitate the receipt of input information by the computing device(s) 400 from one or more I/O devices as well as the output of information from the computing device(s) 400 to one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing device(s) 400 or may be separate. The I/O devices may further include, for example, any number of peripheral devices such as data storage devices, printing devices, and so forth.

The I/O interface(s) 406 may also include an interface for an external peripheral device connection such as a universal serial bus (USB), FireWire, Thunderbolt, Ethernet port or other connection protocol that may connect to one or more networks. The I/O interface(s) 406 may also include a connection to one or more of the antenna(e) 434 to connect to one or more networks via a wireless local area network (WLAN) (such as WiFi) radio, Bluetooth, ZigBee, and/or a wireless network radio, such as a radio capable of communication with a wireless communication network such as a Long Term Evolution (LTE) network, WiMAX network, 3G network, etc.

The computing device(s) 400 may further include one or more network interface(s) 408 via which the computing device(s) 400 may communicate with any of a variety of other systems, platforms, networks, devices, and so forth. The network interface(s) 408 may enable communication, for example, with one or more wireless routers, one or more host servers, one or more web servers, and the like via one or more networks.

The antenna(e) 434 may include any suitable type of antenna depending, for example, on the communications protocols used to transmit or receive signals via the antenna(e) 434. Non-limiting examples of suitable antennae may include directional antennae, non-directional antennae, dipole antennae, folded dipole antennae, patch antennae, multiple-input multiple-output (MIMO) antennae, or the like. The antenna(e) 434 may be communicatively coupled to one or more transceivers 412 or radio components to which or from which signals may be transmitted or received.

The transceiver(s) 412 may include any suitable radio component(s) for—in cooperation with the antenna(e) 434—transmitting or receiving radio frequency (RF) signals in the bandwidth and/or channels corresponding to the communications protocols utilized by the computing device(s) 400 to communicate with other devices. The transceiver(s) 412 may include hardware, software, and/or firmware for modulating, transmitting, or receiving—potentially in cooperation with any of antenna(e) 434—communications signals according to any of the communications protocols discussed above including, but not limited to, one or more WiFi and/or WiFi direct protocols, as standardized by the IEEE 802.11 standards, one or more non-Wi-Fi protocols, or one or more cellular communications protocols or standards. The transceiver(s) 412 may further include hardware, firmware, or software for receiving GNSS signals. The transceiver(s) 412 may include any known receiver and baseband suitable for communicating via the communications protocols utilized by the computing device(s) 400. The transceiver(s) 412 may further include a low noise amplifier (LNA), additional signal amplifiers, an analog-to-digital (A/D) converter, one or more buffers, a digital baseband, or the like.

The sensor(s)/sensor interface(s) 410 may include or may be capable of interfacing with any suitable type of sensing device such as, for example, pressure sensors, moisture sensors, temperature sensors, etc.

It should further be appreciated that the computing device(s) 400 may include alternate and/or additional hardware, software, or firmware components beyond those described or depicted without departing from the scope of the disclosure. More particularly, it should be appreciated that software, firmware, or hardware components depicted as forming part of the computing device(s) 400 are merely illustrative and that some components may not be present or additional components may be provided in various embodiments. While various illustrative program module(s) have been depicted and described as software module(s) stored in the data storage 420, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components, including, for example, software objects, methods, data structures, or the like. Each such software component may include computer-executable instructions that, responsive to execution, cause at least a portion of the functionality described herein (e.g., one or more operations of the illustrative methods described herein) to be performed.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

We claim:

1. A water heater system comprising:
a water heater; and
an exhaust flue for the water heater, the exhaust flue comprising:
a first portion configured to receive flue gases produced by the water heater, wherein the first portion is configured for a first category of venting associated with a positive pressure; and
a second portion configured to receive the flue gases from the first portion, wherein the second portion is configured for a second category of venting associated with a negative or neutral pressure, wherein the second portion is configured to exhaust the flue gases into an existing exhaust vent in an environment of the water heater, wherein the existing exhaust vent is also configured for the second category of venting.

2. The water heater system of claim 1, wherein the first portion of the exhaust flue is configured for category four venting, and wherein the second portion of the exhaust flue is configured for category one venting.

3. The water heater system of claim 1, wherein the exhaust flue further comprises:
a first damper located at the first portion of the exhaust flue, wherein the first damper is configured to regulate an amount of exhaust gas from the water heater that flows through the exhaust flue.

4. The water heater system of claim 3, wherein the exhaust flue further comprises:
a second damper configured to regulate an amount of ambient air that is introduced into the exhaust flue.

5. The water heater system of claim 1, wherein the exhaust flue further comprises:
a first fan configured to draw air from an external environment into the first portion of the exhaust flue.

6. The water heater system of claim 1, wherein the first portion of the exhaust flue is smaller in diameter than at least a portion of the second portion of the exhaust flue.

7. The water heater system of claim 1, wherein the exhaust flue further comprises:
a first moisture sensor disposed at the second portion of the exhaust flue, wherein the first moisture sensor is configured to measure moisture of the flue gases in the second portion of the exhaust flue.

8. The water heater system of claim 7, wherein the exhaust flue further comprises:
a second moisture sensor configured to measure moisture of ambient air.

9. The water heater system of claim 1, wherein the exhaust flue further comprises:
a second fan disposed within the second portion of the exhaust flue.

10. The water heater system of claim 1, further comprising:
a controller configured to:
receive data from a sensor of the exhaust flue; and
transmit, based on the data, a control signal to adjust operation of at least one of: a fan or a damper of the exhaust flue to reduce at least one of: a moisture of flue gases within the exhaust flue or a pressure within the exhaust flue.

11. An exhaust flue for a water heater, the exhaust flue comprising:
a first portion configured to receive flue gases produced by a water heater, wherein the first portion is configured for a first category of venting associated with a positive pressure; and
a second portion configured to receive the flue gases from the first portion, wherein the second portion is configured for a second category of venting associated with a negative or neutral pressure, wherein the second portion is configured to exhaust the flue gases into an existing exhaust vent in an environment of the water heater, wherein the existing exhaust vent is also configured for the second category of venting.

12. The exhaust flue of claim 11, wherein the first portion of the exhaust flue is configured for category four venting, and wherein the second portion of the exhaust flue is configured for category one venting.

13. The exhaust flue of claim 11, further comprising:
a first damper located at the first portion of the exhaust flue, wherein the first damper is configured to regulate an amount of exhaust gas from the water heater that flows through the exhaust flue.

14. The exhaust flue of claim 13, further comprising:
a second damper configured to regulate an amount of ambient air that is introduced into the exhaust flue.

15. The exhaust flue of claim 11, further comprising:
a first fan configured to draw air from an external environment into the first portion of the exhaust flue.

16. The exhaust flue of claim 11, wherein the first portion of the exhaust flue is smaller in diameter than at least a portion of the second portion of the exhaust flue.

17. The exhaust flue of claim 11, further comprising:
a first moisture sensor disposed at the second portion of the exhaust flue, wherein the first moisture sensor is configured to measure moisture of the flue gases in the second portion of the exhaust flue.

18. The exhaust flue of claim 17, further comprising:
a second moisture sensor configured to measure moisture of ambient air.

19. A method for exhausting flue gases from a water heater configured for a first category of venting to an existing exhaust vent configured for a second category of venting, the method comprising:
receiving, by a first portion of an exhaust flue and from the water heater, the flue gases produced by the water heater, wherein the first portion of the exhaust flue is configured for the first category of venting, wherein the first category of venting is associated with a positive pressure;
reducing, by the exhaust flue, a pressure associated with the flue gases within a second portion of the exhaust flue, wherein the second portion of the exhaust flue is configured for the second category of venting, wherein the second category of venting is associated with a neutral or negative pressure; and
exhausting the flue gases into the existing exhaust vent from the second portion of the exhaust flue.

20. The method of claim 19, wherein reducing the pressure of the flue gases further comprises at least one of: adjusting a damper or actuating a fan to change an amount of airflow through the exhaust flue.
